(19) United States
(12) Patent Application Publication
(10) Pub. No.: US 2008/0031600 A1
(43) Pub. Date: Feb. 7, 2008

(54) Method and system for implementing a virtual billboard when playing video from optical media

(76) Inventor: Joshua Robey, Hollis, NH (US)

Correspondence Address: MCANDREWS HELD & MALLOY, LTD, 500 WEST MADISON STREET, SUITE 3400, CHICAGO, IL, 60661, US

(21) Appl. No.: 11/498,997

(22) Filed: Aug. 4, 2006

(51) Int. Cl. G07F 7/00; H04N 5/00

(52) U.S. Cl. 386/126; 705/27

(57) ABSTRACT

Herein described is a method and system of providing advertising content from a third party provider while playing a movie stored in an optical media. The movie is played back as a primary video stream while the advertising content is incorporated as a secondary video stream. One or more visual objects displayed by the movie may serve as one or more virtual billboards. The advertising content is incorporated into one or more virtual billboards as the movie is played. In a representative embodiment, the primary video stream is stored in an optical disc while the secondary video stream is stored in a remote server. The advertising content provided by the secondary video may be modified to suit the needs of the third party provider. The third party provider may comprise an advertising company, a product manufacturer, or a service provider, for example.

### BACKGROUND OF THE INVENTION

When viewing televised programs provided by a television broadcaster, advertisement or commercial time is sold to product manufacturers and service providers. Such commercials may regularly interrupt a broadcasted program that is viewed by a viewer. Commerical time is sold to a product manufacturer or service provider by a television broadcaster to generate revenue.

However, when viewing a program recorded on an optical disc, such as a digital video disc (DVD) for example, such advertisements or commercials are normally not used since they interrupt or disrupt the storyline of the program, and may affect a person's viewing pleasure. As a consequence, it is difficult, if not impossible for a product manufacturer or service provider to advertise its products or services to a viewer of such optical discs.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Various aspects of the invention provide a system and/or method of incorporating video content into a video program using one or more virtual billboards, substantially as shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram of an exemplary frame of composite video generated from combining a primary video and a secondary video, in accordance with an embodiment of the invention.

FIG. 2 is a system diagram illustrating transmission of a secondary video from an Internet server, in accordance with an embodiment of the invention.

FIG. 3 is a functional block diagram of the components of an optical disc player, in accordance with an embodiment of the invention.

FIG. 4 is a functional block diagram of a video engine, such as the video engine previously described in relation to FIG. 3, in accordance with an embodiment of the invention.

FIG. 5 is an operational flow diagram describing the generation and use of a secondary video, in accordance with an embodiment of the invention.

FIG. 6 is an operational flow diagram describing the use of an optical disc that is capable of displaying video content provided by a third party provider, in accordance with an embodiment of the invention.

### DETAILED DESCRIPTION OF THE INVENTION

Various aspects of the invention provide at least a system and method for incorporating one or more “virtual billboards” within a video program. The video program may comprise a movie, for example. A virtual billboard may provide an advertisement related to a product or a service. In a representative embodiment, a viewer views the virtual billboards when he plays a movie stored in an optical media, such as a digital video disc (DVD), for example.

In accordance with various aspects of the invention, a system and method is used for displaying a composite video onto a display. The composite video stream may comprise a primary video stream and a secondary video stream. The primary video stream comprises a video program (e.g., movie) while the secondary video stream comprises content that is added to the video program. In a representative embodiment, the secondary video stream comprises advertising content used to populate suitable areas of the displayed video program. A third party may provide the advertising content, for example. The third party may comprise any entity that advertises a product or service by way of using the “virtual billboards”. Typically, the third party comprises a manufacturer or service provider that wishes to market or promote its products and services, for example. When the secondary video stream is added to the primary video stream, the advertising content is imaged over one or more areas or surfaces of one or more “display vehicles” or “advertising objects” displayed by the primary video stream. These human recognizable objects may be displayed over one or more frames of the primary video stream when the video program is played. In a representative embodiment, the advertising content within these advertising objects may be varied or modified, based one or more characteristics of the audience or viewer. The one or more advertising objects may provide areas or surfaces that are suitable for visualizing an advertisement. For example, a suitable advertising object may comprise a billboard or sign seen within a scene of a movie. In another example, a suitable advertising object may comprise a display of a television set within a scene of a movie. As a consequence, the one or more advertising objects may provide one or more “virtual billboards” which may be used by one or more product manufacturers and/or service providers to advertise their products and/or services. In accordance with the various aspects of the invention, the primary video stream originates from data stored in a media such as an optical disc. In accordance with the various aspects of the invention, the secondary video may originate from an on-line source, by way of a computing device in a network that stores the secondary video, such as a server that is communicatively coupled through the Internet. The server may reside at an Internet service provider (ISP) and may be referred to as an Internet server, for example. The Internet server may be owned and operated, for example, by a telecommunications operator. The Internet server may be adapted to transmit the secondary video to the optical disc player. Further, the Internet server may be adapted to interactively communicate with the optical disc player by way of a modem, such as a cable modem or DSL modem, for example. Alternatively, in accordance with the various aspects of the invention, the secondary video may originate from the media that contains the primary video. Various aspects of the invention are not limited to just a single secondary video stream for providing the advertising content. In other embodiments, one or more secondary video streams may be received from one or more third party entities, such that advertisements for a number products and services may be provided when the composite video is displayed to a viewer.

In accordance with the various aspects of the invention, the secondary video stream may provide advertising content to the primary video stream. The advertising content is displayed using one or more “virtual billboards”. In a representative use of the invention, one or more manufacturers and/or service providers may advertise its products by way of using one or more secondary video streams that provide advertising content for each of the one or more virtual billboards. The one or more virtual billboards may provide a stationary or animated presentation of one or more advertisements displayed to a particular audience.

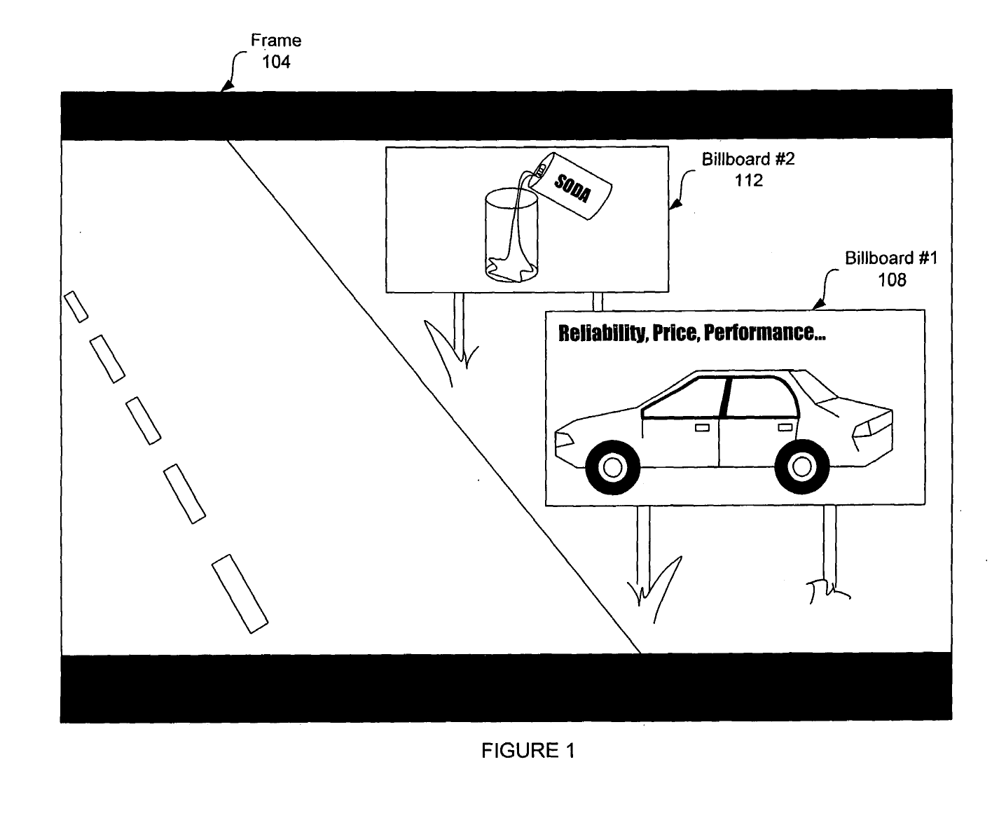

FIG. 1 is a block diagram of an exemplary frame 104 of composite video generated from combining a primary video and a secondary video, in accordance with an embodiment of the invention. In a representative embodiment, as previously described, the secondary video may be provided on-line from a remote server that is communicatively coupled to the Internet, for example. Alternatively, the secondary video may be provided by way of an optical disc. For example, the optical disc may provide both the primary and the secondary video.

In the representative embodiment of FIG. 1, the primary video provides an exemplary frame 104 of a composite video (i.e., primary and secondary video combined). The composite video portrays a scene of a frontal view through a windshield of a vehicle, in which the vehicle is being driven on a highway. The frame 104 illustrates the use of a first virtual billboard 108 and a second virtual billboard 112, posted along a highway in the scene. These virtual billboards 108, 112 may be used to provide advertising to an audience. As shown in FIG. 1, the first virtual billboard 108 comprises a vehicle, for example, that is advertised for its reliability, price, and performance. The second virtual billboard 112 provides an advertisement for a soda, for example. The secondary video may provide a stationary or animated picture for the virtual billboards 108, 112. In this representative embodiment, there are two virtual billboards employed in the composite video; in other embodiments, any number of virtual billboards may be implemented in the composite video.

When the secondary video originates from an on-line source, a remote server may selectively transmit a certain secondary video stream based on one or more factors related to a particular audience. These factors may comprise information related to the viewer and/or his preferences. These factors may be obtained by way of identifying information associated with a modem, for example. The modem and/or optical disc player may interactively communicate with the server while the primary video is being played by the optical disc player. When the secondary video originates from an optical disc, the content of the secondary video is predetermined and stored along with the primary video within the optical disc. In a preferred embodiment, an on-line provider of a secondary video stream may comprise an advertising company or a web serving company that maintains Internet servers. Alternatively an on-line provider of a secondary video stream may comprise a cable operator or telecommunications operator that utilizes a server. The cable operator may act as an Internet Service Provider (ISP), for example. In either case, the one or more Internet servers may store a number of secondary videos used to populate the exemplary virtual billboards 108, 112, based on one or more factors related to the particular audience. The one or more factors may be related to the characteristics or demographics of the audience, for example. In this manner, a product manufacturer or service provider may provide appropriate advertising that targets a particular audience or viewer.

When authoring a video program on a media (e.g., an optical disc), various identifiers or descriptors may be used to specify the location, size, and temporal information of the image to be displayed in a frame. These identifiers or descriptors may be used to properly display a primary and/or secondary video stream, for example. These identifiers or descriptors may be termed and hereinafter referred to as metadata. Metadata may be used to properly process and appropriately display a video stream. In a preferred representative embodiment, the metadata may be stored with the primary video (and optionally with the secondary video) in a playable media. Of course, the playable media may comprise an optical disc, for example. In an alternate representative embodiment, the metadata may be stored with the secondary video in a remote server. An overlay mask of the secondary video may be configured to cover a virtual billboard. Per pixel alpha-blending may be employed when generating composite video from a primary and a secondary video. The advertising content or image(s), used for displaying in one or more virtual billboards, may be modified on a frame by frame basis. To account for movement within a scene, one or more imaging algorithms may be applied to the advertising objects used for generating one or more virtual billboards. In a representative embodiment, the one or more algorithms may be applied over three dimensions of an advertising object. The metadata may incorporate an appropriate scaling ratio to adjust the secondary video to the primary video, an overlay parameter to adjust the overlay mask provided by the secondary video, and offset parameters to place the advertising content provided by the secondary video into correct locations over one or more virtual billboards defined by the primary video. In a representative embodiment, such an authoring process may be performed automatically using a software tool. For example, one or more object recognition and/or tracking algorithms may be used to track the virtual billboard areas from frame to frame. In another representative embodiment, the authoring process may be performed manually by a person who identifies the surfaces of one or more recognizable advertising objects of the primary video. The authoring process may involve masking or marking one or more areas of the primary video that are to be used as virtual billboards. These areas may be masked prior to filming or shooting a movie, for example, such that a specific color may be used for identification of the virtual billboards. In a representative embodiment, the areas to be used as virtual billboards are identified per frame and any information that specifies these areas are stored as metadata in a metadata file. The metadata file may be stored with the primary video (and optionally with the secondary video) in an optical media, such as an optical disc. Alternatively, the metadata file may be stored with the secondary video in a remote server. The creator of the secondary video may utilize this metadata when generating advertising content that will populate the virtual billboards when a viewer watches the composite video. The storage media may comprise an optical disc, for example, while the media player may comprise an optical disc player or DVD player, for example.

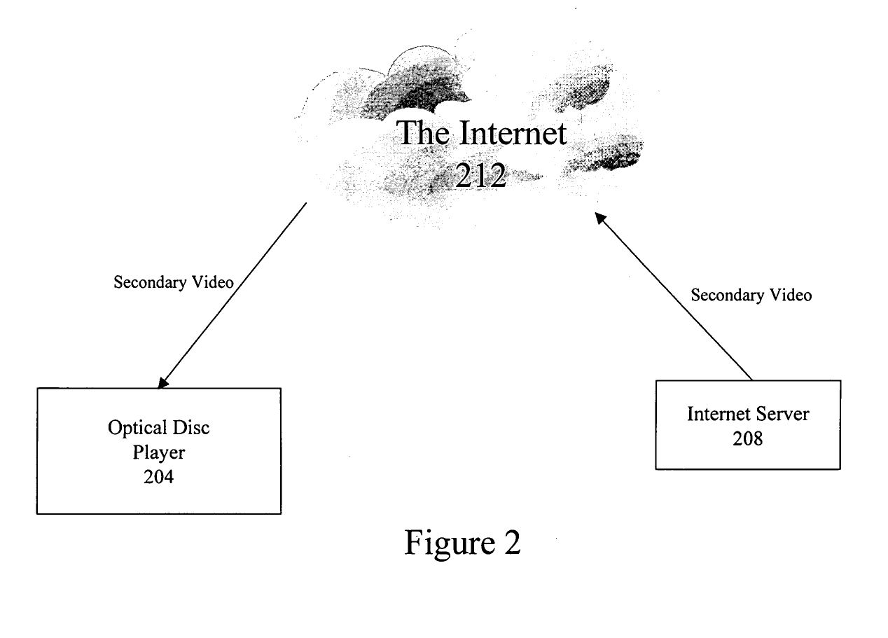

FIG. 2 is a system diagram illustrating transmission of a secondary video from an Internet server 208, in accordance with an embodiment of the invention. The Internet server 208 may be maintained and operated by an advertising company or a web serving company. The secondary video is transmitted by way of the Internet 212 to an optical disc player 204. The secondary video is combined or blended with the primary video to generate a composite video containing one or more virtual billboards. The secondary video may be properly processed using metadata that provides identifiers and descriptors that facilitate proper blending, overlay, and positioning of the secondary video relative to the primary video. The one or more virtual billboards provide advertisements from product manufacturers and/or service providers. Although not shown in detail, customer information may be transmitted to the Internet server 208 by way of one or more networking devices located at the customer premises. The one or more networking devices may be communicatively coupled to the optical disc player. The one or more networking devices may comprise a modem, router, switch, hub, set-top-box, or digital video recorder, for example. The modem may comprise a digital subscriber line (DSL) modem or cable modem, for example. The one or more networking devices may communicate data between the Internet server 208 and the optical disc player by way of the Ethernet protocol, for example.

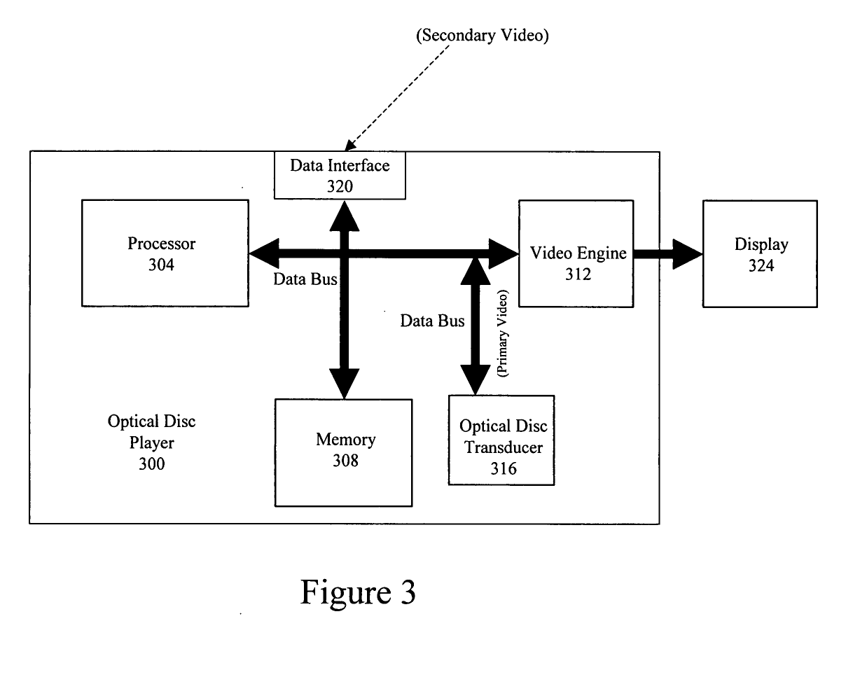

FIG. 3 is a functional block diagram of the components of an optical disc player 300, in accordance with an embodiment of the invention. The optical disc player 300 comprises a processor 304, a memory 308, a video engine 312, an optical disc transducer 316, and a data interface 320. The optical disc player 300 outputs a composite video to a display 324. The display 324 may comprise a television set or monitor, for example. As shown, the components 304, 308, 312, 316, 320 of the optical disc player 300 communicate by way of one or more data busses. The processor 304 may process one or more software programs and/or applications for generating a composite video by appropriately combining a primary video stream and a secondary video stream. The metadata may be stored along with the primary video in an optical disc. The processor 304 may combine or blend the primary and secondary video streams using the one or more software programs and/or applications. The software programs and/or applications may be used to properly decode and display the primary and secondary video streams. The software programs and/or applications may process the primary and secondary video streams, such that the primary and secondary video streams are properly blended/overlayed and one or more virtual billboards are properly displayed. The software programs and/or applications may be stored in the memory 308. The memory 308 may comprise any type of memory, such as a magnetic hard drive or non-volatile flash memory, for example. The data interface 320 may be used to receive one or more secondary videos provided by an external source. The one or more secondary videos may originate from one or more remote servers, for example. One or more network devices, located at the viewer's premises, may be used to receive the one or more secondary videos from the one or more remove servers. The data interface 320 may be used to receive the one or more secondary videos from the one or more network devices, for example. The one or more remote servers may be controlled and operated by an advertising company or a web serving company that maintains Internet servers, for example. The optical disc transducer 316 reads the data stored on an optical disc. In a representative embodiment, the video engine 312 receives secondary video from the data interface 320 by way of a data bus. In another representative embodiment, the video engine 312 receives secondary video from the optical disc. In this embodiment, the optical disc contains the primary and secondary video data. Similarly, the video engine 312 receives primary video from the optical transducer 316 by way of a data bus. The video engine 312 combines the primary video and the secondary video to produce a composite output. The video engine 312 may use the metadata to combine the primary and secondary video. Each of the primary video and secondary video may be processed using metadata. The metadata may be stored in the optical media that contains the primary video. The composite output is transmitted to the display 324.

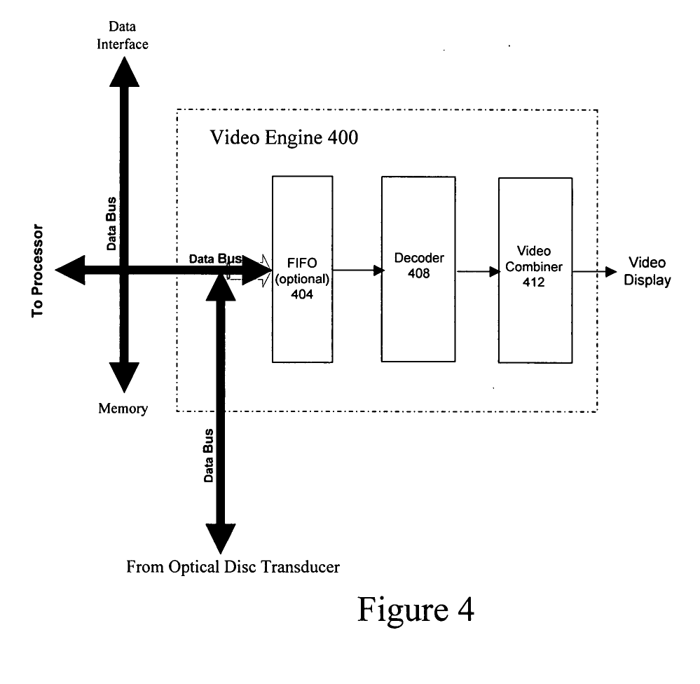

FIG. 4 is a functional block diagram of a video engine 400, such as the video engine previously described in relation to FIG. 3, in accordance with an embodiment of the invention. The video engine 400 comprises an optional first-in-first-out (FIFO) buffer 404, a decoder 408, and a video combiner 412. In certain representative embodiments, the video engine 400 may not utilize or incorporate the FIFO buffer 404 during situations where buffering is not required. The FIFO buffer 404 receives a primary video from an optical disc transducer by way of a data bus, as shown. The FIFO buffer 404 receives a secondary video from a data interface by way of the data bus, as shown. The FIFO buffer 404 transmits the primary and secondary video to the decoder 408 for decoding. The decoder 408 may be used to decode or decompress the primary and secondary video. The primary and secondary video may comprise MPEG video such as MPEG2 or MPEG4 video, for example. The decompressed video may comprise raw video such as YUV or RGB video, for example. The decoder 408 may transmit the decompressed video to the video combiner 412 where the secondary video is combined with the primary video. After the secondary video is combined with the primary video, the resulting composite video is transmitted to a video display. Metadata may be used to properly blend/overlay the primary and secondary videos such that one or more virtual billboards are properly displayed on a display.

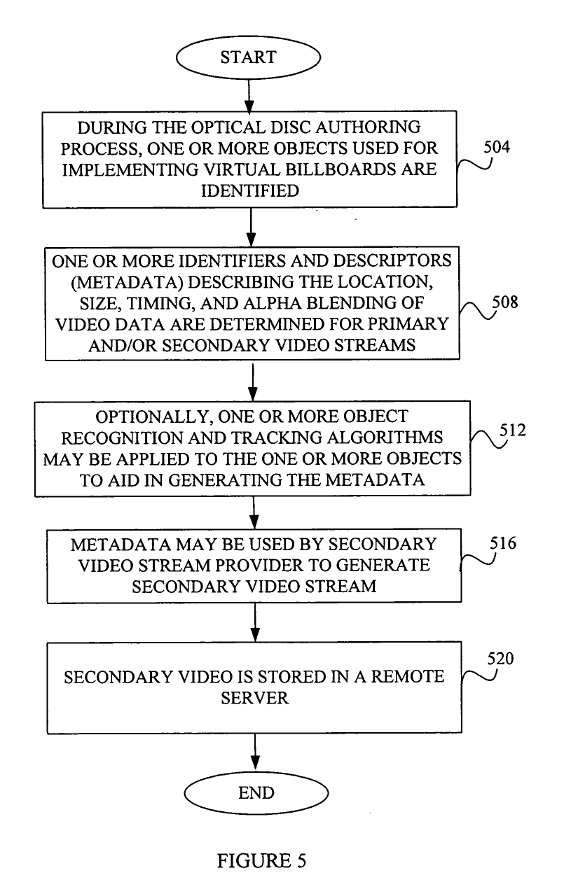

FIG. 5 is an operational flow diagram describing the generation and use of a secondary video, in accordance with an embodiment of the invention. At step 504, an optical disc authoring process commences by way of identifying one or more “display vehicles” or “advertising objects” suitable for use as one or more virtual billboards. The one or more advertising objects may be identified from a primary video. The primary video may comprise a movie to be viewed by a viewer, for example. After the one or more objects are identified, one or more identifiers and/or descriptors may be determined at step 508. These one or more identifiers and/or descriptors may specify location, size, timing and alpha-blending of the primary and/or secondary video stream data. These identifiers and/or descriptors may be described using metadata. Next, at step 512, one or more object recognition and tracking algorithms may be applied to each frame of the primary video as an aid to generating the metadata. The metadata is used to properly display the primary and secondary video such that one or more virtual billboards are implemented. Next, at step 516, the metadata may be transmitted to a secondary video provider. The secondary video provider may utilize the metadata in the creation of the secondary video. Thereafter, at step 520, the secondary video is stored in a network-computing device, such as a remote server. The secondary video stream provider may specify the storage location of the secondary video. The secondary video may be stored, for example, in a remote Internet server located at an Internet service provider (ISP). The Internet server may be maintained by an advertising company or a web serving company, for example.

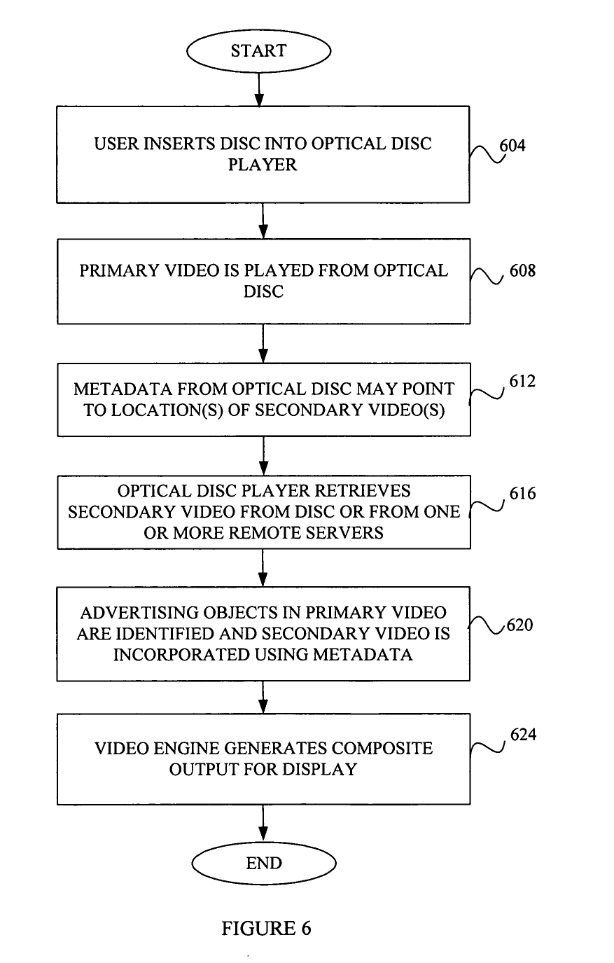

FIG. 6 is an operational flow diagram describing the use of an optical disc that is capable of displaying video content provided by a third party provider, in accordance with an embodiment of the invention. The third party provider may comprise an advertising company or a web serving company that maintains Internet servers, for example. The video content may comprise advertisements or commercials to be positioned in one or more virtual billboards. At step 604, a user inserts an optical disc into an optical disc player. The optical disc player is capable of reading video data and metadata that may be stored in the optical disc. Next, at step 608, a primary video, such as a movie, is played from the optical disc. At step 612, as the primary video is played, the optical disc player may also scan and read metadata stored in the optical disc. The metadata may provide information describing the location of one or more secondary videos. For example, the metadata may specify a URL (Universal Resource Locator). The URL may specify a website or other Internet locations (e.g., FTP servers, data servers, etc.) where the secondary video may be obtained from. In another instance, the secondary video may reside with the primary video in the optical disc. Thereafter, at step 616, the optical disc player retrieves secondary video from the optical disc or one or more remote servers, for example. Then at step 620, one or more objects to be used as virtual billboards are identified in the primary video. Subsequently, video content (e.g., advertising content) provided by the one or more secondary videos may be incorporated into the one or more virtual billboards. The secondary video is combined or incorporated into the primary video by way of using metadata. Next, at step 624, the video engine generates a composite video output to a display.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of authoring an optical disc capable of providing advertising content provided by a third party, said method comprising: identifying one or more advertising objects in a primary video stored in said optical disc, said one or more advertising objects used to implement one or more virtual billboards for displaying one or more secondary videos comprising said advertising content.

2. The method of claim 1 wherein said one or more secondary videos originate from one or more remote servers while said primary video content originates from an optical media.

3. The method of claim 2 wherein said one or more secondary videos are received by way of one or more networking devices used at the viewer's premises.

4. The method of claim 3 wherein said one or more networking devices comprises a modem.

5. The method of claim 4 wherein said modem comprises a digital subscriber line (DSL) or cable modem.

6. The method of claim 3 wherein said secondary video is transmitted by way of the Ethernet protocol.

7. The method of claim 1 wherein said one or more secondary videos and said primary video originate from an optical media.

8. The method of claim 1 wherein said primary video comprises a movie.

9. The method of claim 1 wherein said advertising content may be varied based on viewer information.

10. The method of claim 9 wherein said viewer information may be transmitted by way of one or more networking devices used at the viewer's premises.

11. The method of claim 10 wherein said one or more networking devices comprises a modem.

12. The method of claim 11 wherein said modem comprises a digital subscriber line (DSL) or cable modem.

13. The method of claim 10 wherein said viewer information is transmitted by way of the Ethernet protocol.

14. The method of claim 1 further comprising determining metadata related to said primary and said one or more secondary videos such that said one or more virtual billboards may be properly displayed.

15. The method of claim 14 wherein said metadata comprises one or more identifiers and/or descriptors for describing location, size, timing, and alpha-blending of said primary and said secondary videos.

16. The method of claim 14 further comprising employing one or more object recognition and tracking algorithms to said one or more advertising objects to facilitate generating said metadata.

17. The method of claim 14 wherein said metadata is stored in said optical disc.

18. An optical disc player for displaying advertising content provided by a third party while viewing a video program comprising:
a video decoder; and
a video combiner, said video decoder used to decode said primary and said one or more secondary videos, said video combiner used for combining said primary video and said one or more secondary videos, said video decoder transmitting to said video combiner, wherein said advertising content is displayed using one or more objects in said primary video.

19. The optical disc player of claim 18 wherein said video combiner utilizes metadata for combining said primary video and said one or more secondary videos.

20. The optical disc player of claim 19 wherein said metadata defines the location, size, timing, and alpha-blending of said primary and said one or more secondary videos.

21. A method of playing a video program that incorporates advertising content into one or more advertising objects comprising:
using an optical disc that stores said video program;
accessing metadata previously stored in said optical disc;
using said metadata to locate one or more secondary videos;
retrieving said one or more secondary videos containing said advertising content; and
using said secondary videos to display said advertising content using one or more virtual billboards.

22. The method of claim 21 wherein said one or more secondary videos are located in one or more remote servers.

23. The method of claim 21 wherein said one or more secondary videos are located in said optical disc.

24. The method of claim 21 wherein said advertising content is determined based on viewer information.

25. The method of claim 21 wherein said viewer information is obtained using one or more network devices located at the viewer's premises.

26. The method of claim 21 wherein said advertising content comprises an animated presentation.
